(19) United States
(12) Patent Application Publication
(10) Pub. No.: US 2007/0282542 A1
(43) Pub. Date: Dec. 6, 2007

(54) Composite trigger for a digital sampling oscilloscope

(76) Inventors: Christopher P. Duff, Colorado Springs, CO (US); Scott Allan Genther, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/444,646

(22) Filed: May 31, 2006

(51) Int. Cl. G01B 5/28; G01B 5/30; G06F 19/00

(52) U.S. Cl. 702/35

(57) ABSTRACT

A Composite Trigger for a DSO provisionally honors a conventional hardware trigger by algorithmically investigating the content of the associated Acquisition Record for a selected signal attribute (a S/W Trigger). If found, the hardware trigger is fully honored by displaying the Acquisition Record with a previously selected time scale and with the time reference set to where in the trace the selected signal attribute occurs. The selected attribute may include the occurrence of a stated value or stated range of values for any automatic measurement upon a trace that the 'scope is otherwise equipped to perform. In addition to being based on existing automatic measurements, the Composite Trigger can also be satisfied whenever subsequent investigation determines that a segment of trace described by the Acquisition Record does or does not pass through one or more zones defined relative to an existing time reference. The Composite Trigger can also be based on whether a trace can be interpreted as exhibiting a selected serial bit pattern, or, upon whether the trace represents an edge that is not monotonic.

### INTRODUCTION AND BACKGROUND

An oscilloscope needs a way to make consecutive segments of a repetitive waveform ‘stand still’ when displayed. In the old days of uncalibrated horizontal sweep speeds this was done by varying the frequency of the sawtooth waveform that provided the horizontal sweep, until synchronism produced a stable display. Typically, some variable amount of the vertical input signal was coupled into the sweep oscillator to ‘encourage’ it to remain synchronized (as through a rudimentary sort of phase locking). Later, when analog 'scopes were equipped with calibrated sweep speeds, synchronization was obtained by triggering individual cycles of the sweep oscillator by a threshold detector driven by a conditioned version of the vertical input signal. This manner of triggering has survived, and even today's Digital Sampling Oscilloscopes (DSOs) use a refined version of this, which technique we shall term a ‘hardware trigger’ (H/W Trigger).

High performance analog 'scopes included a delay line in the vertical signal path for deflection, but not in the path for the hardware trigger signal. This allowed the 'scope to actually display (for faster signals and at the fastest sweep speeds, anyway) the event that produced the trigger. The nature of the DSO is such that this delay line is not required. True to its name, the DSO samples the input signal to create digital values. These digital values are placed in an Acquisition Memory, which can generally be likened to a circular buffer having a substantial number of addressable locations. Just as the analog ‘scope’s vertical amplifier was always supplying a signal to the vertical deflection plates of the CRT (Cathode Ray Tube), so that all that needed to be done upon triggering was to unblank the electron beam and begin horizontal deflection, the DSO is ‘always’ filling the Acquisition Memory with samples, a related collection of which is called an Acquisition Record. The DSO, however, does not perform anything like a horizontal sweep, and instead operates upon and transfers the Acquisition Record in the Acquisition Memory to a Frame Buffer from whence a raster type display is produced. For a ‘live’ display expected to show ongoing changes in successively captured waveforms (i.e., the ‘scope is continuously in a ‘RUN’ mode), the display is maintained for only a minimal or brief time, and is then replaced with new data just as soon as it is available (i.e., if there has been another trigger and another Acquisition Record). In the case where the ‘scope is STOPed while running, or is triggered once while in a ‘SINGLE’ mode, the Frame Buffer (and the display thereof) remains unaltered until the operator instructs otherwise.

The fact that a DSO has memory gives it at least two distinct advantages over its analog predecessor. The first of these is related to bandwidth. It turns out that to get all the components in the vertical path of an analog 'scope to perform at high bandwidths is a significant engineering challenge. DC coupled amplifiers that will produce a hundred or more volts peak to peak at several gigahertz at a CRT's vertical deflection plates are not practical, not to mention that the writing rate for a normal CRT does not go that high. Even before the DSO, the highest frequency analog 'scopes were sampling analog oscilloscopes (as opposed to ‘real time’ analog oscilloscopes) that relied upon regularly spaced (analog!) samples taken upon a repetitive waveform to recreate on the CRT an analog image of the input waveform. These analog samples (say, the charge on a tiny capacitance acquired during a very brief duration), when considered in sequence, formed a ‘slow moving’ analog voltage replica of the (‘fast moving’) applied input voltage. What the DSO does is take the sample and digitize it, and then store in the Acquisition Memory. (The DSO might take the samples consecutively within a segment of an applied signal and at a very high rate for ‘real time’ operation or for ‘single shot’ operation, or it might let locations sampled at a slower rate drift across repeated cycles of the input signal for ‘repetitive sampling,’ also called ‘equivalent time’ operation.) It is then evident that once the digitized values are stored, they can be ‘played back’ at a convenient rate from a Frame Buffer using low cost raster scan techniques that are not affected by the possible high frequency (say, 20 GHz or more) nature of the applied input signal. The underlying technical issue here is that it is far easier to design and build high speed samplers and ADCs (Analog to Digital Converters) and fashion a high speed path into memory (say, by interleaving many banks of memory) than it is to design and build the equivalent actual analog signal path (amplifiers and CRT).

The second distinct advantage of the DSO over its analog parent arises because of the persistence of memory. Whereas the analog 'scope was forced to “view the signal end-on, process it in real time and get rid the fleeting result” right away, the DSO “views the signal end-on but creates a ‘side view’ of its activity over a segment of time that is ‘permanent’” and that can be leisurely, as it were, processed, viewed and otherwise given a suitable disposition.

The notion that the signal's waveform is represented by a collection of digitized values in a memory allows a powerful extension of the notion of triggering. Whereas the analog 'scope could only unblank the beam and start the sweep subsequent to the occurrence of a trigger, the DSO can allow the operator to decide where the trigger event is to be relative to the start and end of the Acquisition Record. So, for example, if the creation of the Acquisition Record is continued until it is about to overwrite in the circular Acquisition Memory the location corresponding to (or most nearly corresponding to) the time when the trigger event occurred, then the Acquisition Record is a trace of activity occurring subsequent to the trigger, just as for analog ‘scopes. But if the creation of the Acquisition Record is stopped immediately upon the occurrence of the trigger event, then what the Acquisition Record contains is the activity that lead up to the trigger (so called ‘negative time’). This can be an invaluable feature that simply isn't possible with the old analog architecture, and we may speculate that this, in conjunction with the bandwidth issue, is what accounts for the decline in popularity of the ‘laboratory grade’ analog oscilloscope in favor of the modern DSO. If the creation of the Acquisition Record is continued for, say, half its length, then we have captured activity both before and after the triggering event.

Now let the Acquisition Record be substantial in size, perhaps large enough that it is apparently very many times wider than the Frame Buffer. A Frame Buffer might have, say, just one or two thousand addressable locations, because the physical display device has just that many horizontal pixel locations. But if the Acquisition Record has several million (or several tens of millions) of addressable locations, then there arises the issue of how to decide what image to store in the Frame Buffer.

The operator may decide to ‘zoom out’ and let the end points of the Frame Buffer correspond to the start and end of the Acquisition Record. (Recall that the Acquisition Memory is managed as though it were a circular buffer, so those starting and ending locations in the resulting Acquisition Record are generally nearly adjacent, and located ‘anywhere along the circle,’ as it were.) The resulting displayed trace is, of necessity, severely compressed along the horizontal (time) dimension, and some clever rendering techniques are often required to create a useful image that is not downright deceptive and that correctly conveys some general sense of what signal activity is actually going on.

On the other hand, the operator may decide to view just a segment of the total Acquisition Record, and at a time scale selected from among predetermined choices. That is, within certain limits, the operator can both zoom and pan along the horizontal axis. This kind of operation has become (after the eventual emergence of user friendly controls to do it) the distinguishing hallmark of the DSO: those stuck with older analog equipment could only view with envy the measurements that their more newly equipped brethren could perform.

On the other hand, with this kind of flexibility comes some inevitable complexity. In this case, the notion of triggering carries a bit more meaning than it did before. Typically, the location of the triggering event now becomes simply a reference point in time to which the content of the Acquisition Record is relative. Depending upon decisions made concerning the selected time scale for the displayed segment and its location within the Acquisition Record, the segment rendered into the Frame Buffer for display might or might not include the location in time corresponding to the trigger event. Various ways have been developed to annunciate the information concerning the location of the trigger relative to what is shown in the display, and how the displayed segment relates to the overall Acquisition Record.

Since the DSO maintains a digital record in memory of signal behavior, measurements concerning signal behavior that were once made by operator observation of the trace on the CRT's screen can now be made by algorithmic process within the ‘scope itself. Examples include peak-to-peak voltage, average voltage, RMS voltage, rise and fall times, period, frequency, jitter, etc. The actual list of such measurements for high end DSOs contains as many as fifty or sixty separate items, not to mention the ability to create arithmetic combinations of the waveforms for different channels, as well as transforms from the time domain to other representations (e.g., Fourier transformations into the frequency domain). Collectively, we shall refer to such abilities as ‘automatic measurements’ and expect any such automatic measurement to have associated with it a numerical value that is available for comparison to a threshold value, or range, to be provided. (By ‘automatic’ we mean that the measurement can proceed under algorithmic control by inspecting the contents of the Acquisition Record, without a subsequent need for ongoing user intervention.) We mention this idea of automatic measurement now, since we will encounter it again.

This notion of having a digitized version of a segment of data has worked a revolution in the architecture and performance for several types of electronic test equipment, and it continues to provide a venue for improvements in the DSO, as well. We have seen that triggering is a process fundamental to the operation of an oscilloscope. As the vertical bandwidth of a ‘scope increases there is a corresponding need for increased speed in the correct recognition of conditions within an input signal that could qualify as a trigger event. To date, the task of triggering has remained much as it has since the development of the hardware trigger for analog ‘scopes with calibrated sweeps, and is still principally a real time process implemented with rather carefully designed hardware (but which typically does not have an overall bandwidth comparable to that of the vertical signal path).

What a modern ‘scope typically provides in its H/W Trigger Circuit includes the abilities to:
Select a signal of interest from which to trigger, which may be one that has a displayed trace (Internal triggering) or some separate (External) signal;
AC or DC couple the signal of interest to the H/W Trigger circuit;
Discriminate against or enhance some either low or high frequency components in the signal coupled to the H/W Trigger circuit;
Periodically trigger itself automatically at some preselected rate and independently of any external events to produce a ‘free-running’ or ‘auto-triggering’ display (synchronism is evidently not an issue here, but a mere indication of activity might be . . . );
Trigger on the AC power line; and
Institute criteria to recognize in a waveform an industry standard feature, such as a sync pulse for a television signal.

In addition, the resulting trigger signal produced by a H/W Trigger Circuit might be delayed by some variable amount (‘hold-off’) or used to initiate an entirely separate section of sweep at a faster sweep speed after a selected delay (‘delayed sweep’).

Some investigators have proposed using the digitized data in the Acquisition Record as a source of trigger criteria, a notion that we shall refer to as a ‘software trigger’ (S/W Trigger). The attraction is that much more complicated trigger conditions could be employed to assist in, say, the discovery and identification of elusive anomalous events or conditions. Now, rather than characterizing analog events in real time as they occur on a conductor with a genuine analog (H/W Trigger) circuit, the natural tendency is to utilize a stepwise programmed mechanism to implement an appropriately tailored algorithm that investigates the contents of the Acquisition Record. This would be a fine thing indeed if it could be done at full speed upon newly acquired values as they were written to that Acquisition Record. Then there would be a least a fighting chance of getting the trigger decision made in time to stop the overwriting of the Acquisition Record and preserve most of what led up to the trigger event. As more time is required to arrive at a trigger decision (i.e., the more the “circular portion of the Acquisition Record is ‘used up’”, the more likely that the ‘scope would only be able to display events after (perhaps only way after) the trigger event. Unfortunately, such full speed operation turns out to be impractical for high rates of data sampling. The latency of program execution for ordinary microprocessors is simply too much to even consider, while the high speed operation offered by special purpose architectures, such as FPGAs (Field Programmable Gate Arrays), suffers from issues such as cost and ease of re-programming while in use, not to mention that it is a significant challenge to get the stuff to really go that fast and to not break an existing ‘scope architecture when incorporating it into the data path. To date, these rather significant issues have prevented such an algorithmic (think: ‘software’ or ‘firmware’) trigger from appearing as a feature for a commercial DSO.

Still, the lure of all that potential powerful triggering is strong: “This ##@&*% thing <a circuit or assembly under development> has run off the tracks and is in the bushes again!! What made it do that?? The hardware trigger is way too general, and I wish this ‘scope could be triggered on this <some weird/peculiar/very particular> combination of signal behaviors . . . .” It's a whodunit, all right, but a conventional DSO's hardware trigger is of little help. What to do?

### Simplified Description

A DSO is equipped with a Composite Triggering ability that, when in effect, provisionally honors a conventional hardware trigger by algorithmically investigating the content of the associated Acquisition Record for a selected signal attribute, whose definition is called a S/W Trigger. If that selected signal attribute is found (the S/W Trigger is met), the hardware trigger is fully honored by displaying the Acquisition Record with a previously selected time scale and with the time reference set to where in the trace the selected signal attribute occurs. The selected attribute for the S/W Trigger may include the occurrence of a stated value or stated range of values for any automatic measurement upon a trace that the ‘scope is otherwise equipped to perform. In addition to being based on existing automatic measurements, the Composite Trigger can also be satisfied whenever subsequent investigation determines that a segment of trace described by the Acquisition Record does or does not pass through one or more time-amplitude regions (zones) defined relative to an existing time reference. The Composite Trigger can also be based on whether a trace can be interpreted (with the aid of clock recovery) as exhibiting a selected serial bit pattern, or, upon whether the trace represents an edge that is not monotonic. In the event that the trace satisfies the selected signal attribute at more than one location, the first location found is the one that is used. Subsequent to a successful Composite Trigger, the ‘scope will either STOP, or display briefly and then continue to RUN, just as it would as in the case where the triggering event were solely a conventional hardware trigger. Just as for conventional Hardware Trigger, when the Composite Trigger Mode is in effect the only traces that will appear in the display will be those that satisfied the Composite Trigger. Furthermore, a copy of the Acquisition Record that produced the successful Composite Trigger will be kept intact until the next successful Composite Trigger. A handy GUI (Graphical User Interface) is supplied to assist the user in defining the Acquisition Record dependent aspects of a Composite Trigger specification.

### BRIEF DESCRIPTION OF THE DRAWINGS

FIG. 1 is a simplified block diagram of a prior art DSO that includes only a hardware trigger capability;

FIGS. 2A-B are a collection of simplified flowcharts describing internal activity for a DSO that includes a Composite Trigger capability;

FIGS. 3-5 are illustrations depicting the use of an automatic measurement as the S/W component of a Composite Trigger;

FIG. 6 is an illustration of the use of a serial bit pattern as the S/W component of a Composite Trigger;

FIGS. 7-10 are illustrations depicting the definition of zones and their use as S/W components of a Composite Trigger;

FIG. 11 is an illustration of the use of a non-monotonic region of a trace as the S/W component of a Composite Trigger; and

FIG. 12 is an illustration of the use of a RUNT excursion in a trace as the S/W component of a Composite Trigger.

### DETAILED DESCRIPTION

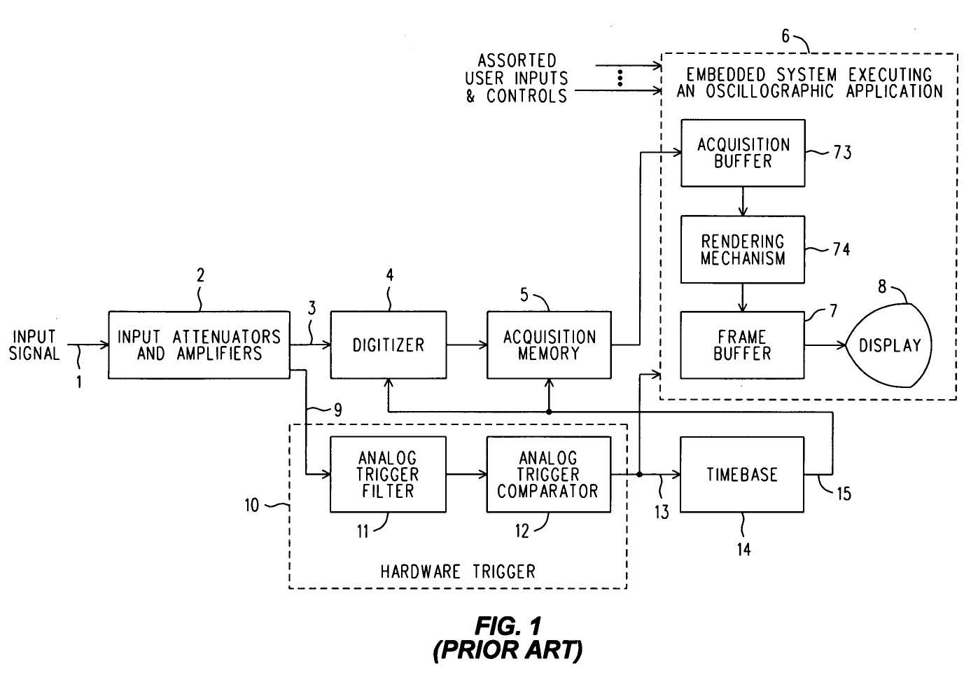

Refer now to FIG. 1, wherein is shown a simplified block diagram of a prior art DSO architecture that uses a conventional Hardware Trigger (10), and that may be taken as a point of departure for the implementation of a Composite Trigger that includes a S/W Trigger component. In particular, an Input Signal 1 in applied to various Input Attenuators and Amplifiers 2, where signal conditioning takes place. A Conditioned Input Signal 3, which will be a suitable replica of the Actual Input Signal 1, is applied to a Digitizer (or ADC—Analog to Digital Converter) 4 whose output is a series of digital words (preferably integers) of a suitable number of bits, say eight or ten, depending upon the vertical resolution the DSO is to have. The series of digital words is applied to an Acquisition Memory 5 that stores them internally as an Acquisition Record (a data structure, and not itself shown). To free the Acquisition Memory to begin as soon as possible to begin acquiring another Acquisition Record, the content of the Acquisition Memory is transferred to an Acquisition Buffer 73.

An Embedded (computer) System 6 executes an Oscillographic Application that implements the majority of the control settings for the ‘scope, and interprets the Acquisition Record stored within the Acquisition Buffer in light of those control settings. It executes a Rendering Mechanism 74 (a programmatic mechanism stored in firmware) that renders the buffered Acquisition Record into bit mapped data stored in a Frame Buffer 7. The content of the Frame Buffer is displayed on a Display 8 as a trace with suitable annotations and other messages for the operator. The Embedded System 6 may be located within a traditional bench-top laboratory grade ‘scope, and it will be understood and appreciated that, for the sake of brevity, we have in this simplified figure suppressed the details of the user interface and the mechanisms by which the Oscillographic Application controls the operation of the DSO in response to indications from the operator.

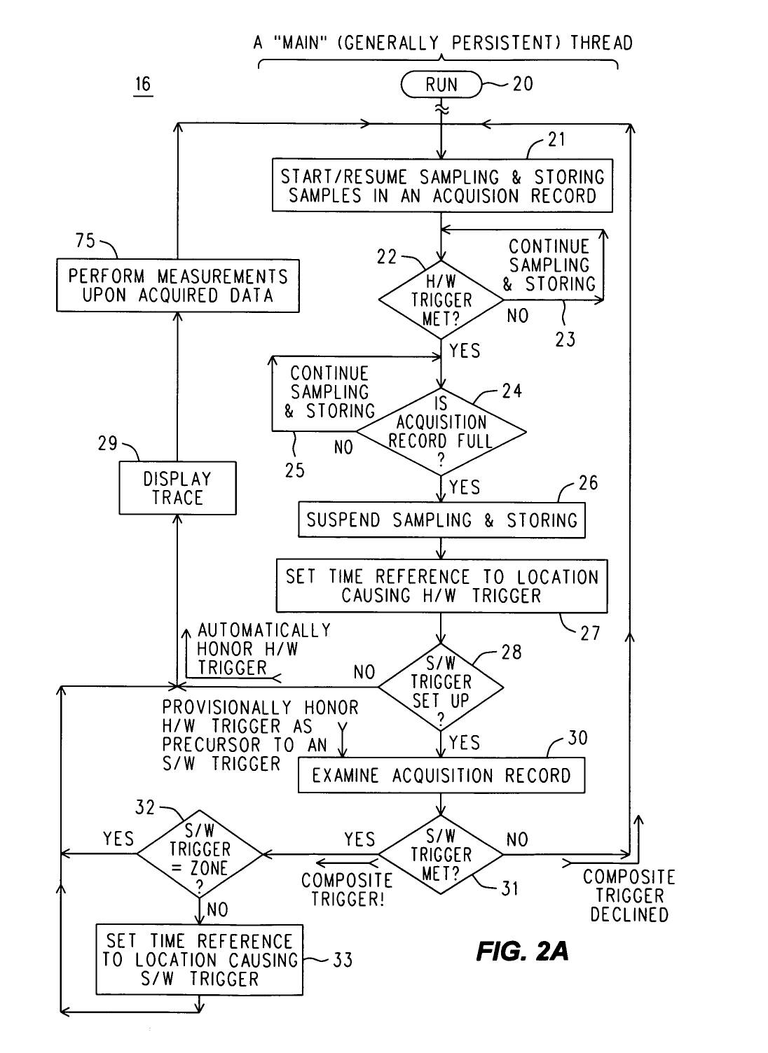

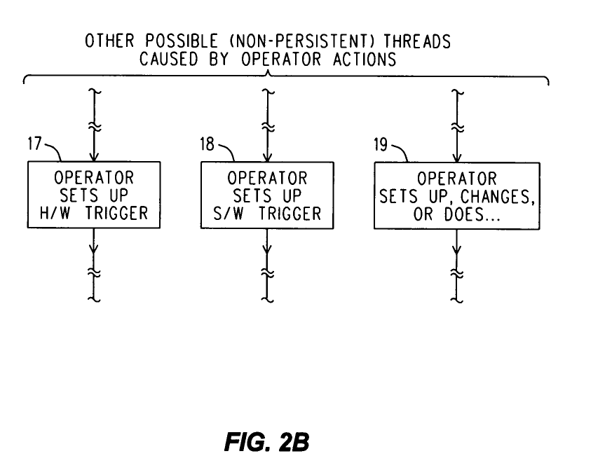

The architecture shown in FIG. 1 is (and is for FIG. 2) also applicable in the case where the acquisition hardware for the ‘scope is a ‘faceless box’ connected to a stand-alone computer through a suitable interface. (It will be appreciated that in such a situation there is A LOT of traffic over that interface . . . .) While not as popular as they were at one time, they still exist, and the improvement we are about to describe is equally applicable to that architecture, as well.

The rates of taking the digital samples by the Digitizer 4 and of their storage as an Acquisition Record within the Acquisition Memory 5 is determined by a Time Base 14. The Digitizer might sample only in response to transitions in a signal from the Time Base, after which the sample is stored in the Acquisition Memory, or the Digitizer might operate at full speed, but with only every nₜₕ sample being stored (so-called ‘decimation’). To continue, the usual technique is for the Acquisition Record within the Acquisition Memory to function as a circular structure, where the earliest stored data is overwritten once the Acquisition Record is full. This behavior continues until a trigger event occurs, whereupon some preselected number of further samples is stored, followed then by the interpretation of the completed Acquisition Record and the preparation and display of a trace.

In the block diagram of FIG. 1, a version 9 of the Conditioned Input Signal is applied to an Hardware Trigger 10, which is composed mainly of a Trigger Filter 11 and a Trigger Comparator 12. The filters are typically analog filters of the high-pass and/or low pass variety, and one or more of these is selected to operate on the Conditioned Input Signal 7. The filtered result is applied to a Trigger Comparator 9, which may be essentially a high speed adjustable threshold detector, whose output is a Time Base Trigger 13.

The Time Base Trigger 13 may be applied to the Time Base 14, as well as to the Embedded Control System 6. It is not so much (as it was in the old analog ‘scopes) that the Trigger Signal ‘turns on’ or starts the Time Base to produce a ‘sweep’—it was already doing what it needs to do to facilitate the sampling of the Actual Input Signal 1 and the storing of the Acquisition Record, as mentioned above. Instead, the DSO may recognize that: (1) Subsequent to the trigger event one or more stored samples need to be associated with that trigger and that a certain number of additional samples might still need to be acquired and stored, after which the Acquisition Record is complete; and, (2) The trigger event (as indicated by an edge in the Trigger Signal) is not constrained to occur only at times when a sample is taken. The implication is that the trigger event might not correspond exactly to one sample explicitly contained in the Acquisition Record, but actually corresponds to a location in time between two adjacent entries in the Acquisition Record. Nevertheless, it is desired to correctly indicate where on the displayed trace the trigger event happened. To do this we need to know (and keep track of) a time offset between when the trigger event occurred and the adjacent active edges from the Time Base.

After the Acquisition Record has been formed and buffered, the Oscillographic Application renders into the Frame Buffer 7 a bit mapped version of a trace according to the control settings that have been established by the operator.

As an aside, we offer the following comment on the operation of the architecture just described. It would be possible for the computer mechanism of the Embedded System and the Oscillographic Application it executes to be intimately involved in controlling every little detail—for all of the ‘smarts’ to be in that program, as it were, and for all the hardware to be as ‘dumb’ as possible. That puts a large burden on the program, and it may not be economical for it to run fast enough to properly control a ‘scope that takes high speed measurements. Accordingly, hardware blocks shown in FIG. 1 are as ‘smart’ as possible. They get told their operational parameters and then they carry them out autonomously. So, for example, the Acquisition Memory knows ahead of time how many more samples to store once the hardware trigger signal (Time Base Trigger 13) has occurred. The idea is to off-load the high speed decision making to circuits associated with the decision and that already operate at high speed, and allow a relatively slow application program to worry mostly about things that happen before or after the actual measurement, such as conducting the user interface and post processing the sampled data to render a trace. It is this latter ‘smart hardware’ arrangement that is preferred, and it also helps explain why we don't show an extensive collection of control lines between the Embedded System 6 and the rest of the hardware, and why we don't consider the Acquisition Memory 5 to ‘belong’ to the processor-memory combination that is so essential to the notion of a programmed computational mechanism (6). Furthermore, it will be appreciated that the exact division of labor between the various hardware blocks varies from one DSO vendor to the next, and that if we appreciate the overall result, we needn't be too concerned over the details of any particular strategy for deciding what goes into each of the various blocks.

Now consider the flowcharts 16-19 of FIGS. 2A-B. These represent various threads, or related collections of actions (in the sense of a coherent process) undertaken by the firmware executed by the Embedded System 6 in response to circumstances affecting the DSO. So, for example, thread 16 is a somewhat simplified representation of the collection of activities related to the DSO being in the RUN mode, or state. That is, the operator has pressed the RUN button (not shown) on the front panel and the ‘scope is sampling data and storing it in an Acquisition Record, in anticipation of there being a H/W Trigger. This is a “persistent” thread, in that its operation is repeated indefinitely, for as long as the DSO is in RUN. The other threads (17, 18, 19) represent non-persistent threads that are completed once an instance of some particular component-like action has been accomplished (e.g., set up a trigger condition). These non-persistent threads have been shown, not only so that as a class they can be distinguished from the persistent ones, but also so that the overall nature of the H/W Trigger and S/W Trigger set-up operations (17, 18) can be seen in relation to the “main” data acquisition thread 16. All of these various threads (as well as many others that have not been shown) can be thought of as being “spawned” on an as needed basis from a “supervisory” thread (not shown) that is essentially an idle loop that is responsive to activation or manipulation of the various controls on the DSO.

One might wonder why we bother with the notion of “threads” instead of simply saying “Here are these flowcharts . . . ”, particularly when it is rightly suspected that one microprocessor core can only execute one instruction at a time. Our motivation comes from the following considerations. In a traditional flowcharting environment you put one finger at one place on one flowchart, and that describes at some level of abstraction what the system is doing and will do next. If there is an urge for another and separate activity to proceed, then another finger is needed. Things can get fairly complicated rather quickly if the separate flowcharts are allowed or expected to influence each other. This is particularly so if a time slicing/context switching mechanism(as in Unix or Linux) is used to ‘simultaneously’ execute the different processes. What is more, there might be more than one processor core, or special purpose autonomous hardware mechanisms that run fast (e.g., state machines, FPGAs) and that are dedicated to executing just one flowchart. The overhead for achieving the simultaneity (whether real or faux) is almost never visible at the flowchart level, and even inter-flowchart communication mechanisms, such as flags, semaphores and mail boxes, are apt to conceal as much truth as they afford value in terms of utility. This notion of threads is a generalization that acknowledges that those fussy issues do exist, but says that they belong to a particular implementation in a particular environment, and that if we agree to operate at a useful level of abstraction, we can keep the familiar flowcharts, with the understanding that: we might need many fingers; that flowcharts can and do appear and disappear under the control of some environmental overhead mechanism that we don't need to study; and that the rate of progress for one flowchart is not necessarily the same as for another. The useful grouping of such related activities/processes into coherent separate unified descriptions (our simplified flowcharts of FIGS. 2A-B) are the things we are calling threads.

Now consider the flowchart 16 in FIG. 2A. It describes a generally persistent thread associated with the implementation of a Composite Trigger having a S/W Trigger component. It begins with the user having pressed the RUN button on the front panel, causing an ‘exit’ 20 from a supervisory idle loop responsive to input from the operator. Step 21 of the flowchart 16 represents that the DSO begins to take samples and puts the digitized values for those samples into an Acquisition Record stored in the Acquisition Memory 5. (That is, an autonomous combination of the Time Base 14, Digitizer 4 and Acquisition Memory 5 is configured and its operation begun.) This RUN mode behavior will continue until there is a trace to be displayed (trigger criteria have been met), although it might happen instead that the operator has a change of heart and presses STOP before a trace is ready, in which case the execution of the thread described by flowchart 16 is aborted ( in which case we note that any previously acquired Acquisition Record that got moved into the Acquisition Buffer 73 is still present and remains available). If the entry into step 21 is directly from the RUN exit 20, then we can say that step 21 ‘starts’ sampling (an alternative ‘resume’ idea will be mentioned in due course).

Step 21 is followed by qualifier 22, which asks if the H/W Trigger has been met. If the answer is NO, then a loop 23 is formed by waiting at qualifier 22 until the answer is YES. For the duration of this loop we can say that loop 23 ‘continues’ sampling.

Eventually, there will (presumably) be a YES answer at qualifier 22. This does not necessarily mean that the acquisition record is complete. For example, if the operator has (previously) specified that the Time Reference is to be is to be at the middle of the Acquisition Record, then at the time of the H/W Trigger only half of the desired Acquisition Record has been obtained, and the process of sampling and storing needs to continue to obtain the remaining half. Thus it is that qualifier 24 asks if the Acquisition Record is full, and if the answer is NO, then a loop 25 is formed that, as did loop 23, continues sampling and storing until the answer is YES.

Upon a YES answer at qualifier 24, step 26 ‘suspends’ sampling and storing, but without re-configuring the combination of the Time Base 14, Digitizer 4 and Acquisition Memory 5.

Next, qualifier 28 asks if a S/W Trigger has been set up, which would indicate an intent of operating the DSO with a Composite Trigger. If the answer is NO, then the thread proceeds to step 29, where the trace corresponding to the content of the Acquisition Record is displayed for at least brief period of time. Following that, step 75 examines the Acquisition Record to perform any automatic measurements that might have been specified. If the operator should press the STOP key, then the thread of flowchart 16 is abandoned, and the displayed trace would remain visible until the operator does something else. On the other hand, if there is no STOP and RUN remains in force, then the thread is producing a ‘live’ display, which is obtained by returning to step 21 at the conclusion of the brief time associated with the display at step 29 (this is the ‘RESUME’ idea mentioned above). The purpose of the brief delay at step 29 is so that the trace will be displayed for at least a perceptible length of time and thus actually be visible. In the live display situation the trace will remain displayed until it is replaced by one associated with the next trigger event. The rate of apparent change in the displayed trace is thus limited by the sum of the brief delay and the time required to obtain a full Acquisition Record having an associated trigger event.

The operation just described for a NO answer at qualifier 28 can be described as automatically honoring a H/W Trigger, since one did occur, and no S/W Trigger has been specified and no Composite Triggering is being attempted.

The answer at qualifier 28 might be YES, which is a case that we are particularly interested in. We can say that a YES answer at qualifier 28 is a provisional honoring of a H/W Trigger in anticipation of a possible Composite Trigger, the occurrence of which will now ultimately depend upon conditions within the Acquisition Record.

Accordingly, in the case of a YES answer for qualifier 28, the next step 30 is to examine the Acquisition Record for the existence of the condition described by the S/W Trigger criterion. The location of the Acquisition Record to examined might be either the Acquisition Memory 5 or the Acquisition Buffer 73. We shall have more to say about what the examination criteria might be, but for now it is sufficient to think of them as certain properties of a waveform that can be discovered as present or that can be measured. Once the Acquisition Record has been examined by step 30 a decision can be made at qualifier 31 as to whether the S/W Trigger criterion (whatever it is) has been met. If the answer is NO, then the specified S/W Trigger condition has not been met, the opportunity to perform a Composite Trigger is declined, and the entire process thus far described for the thread begins again with a transition back to step 21, so that another candidate Acquisition Record can be obtained for continued operation under the Composite Trigger regime.

On the other hand, if the answer at qualifier 31 is YES, then an instance of Composite Triggering (H/W Trigger then a S/W Trigger) has been achieved. At this juncture, a decision with qualifier 32 is made as to the nature of the S/W Trigger. If it is a ‘zone’ type S/W Trigger (to be explained in due course) then the Time Reference is left set to where it was located in step 27, which location is for the H/W Trigger. This is accomplished by the NO branch from qualifier 32 leading directly to step 29. Otherwise, the Time Reference is set by step 33 to the location in the Acquisition Record that met the S/W Trigger criterion.

The ‘live display’ versus STOP remarks made above pertaining to the H/W Trigger only (NO at qualifier 28) apply equally to the YES branch from qualifier 31 for Composite Trigger operation

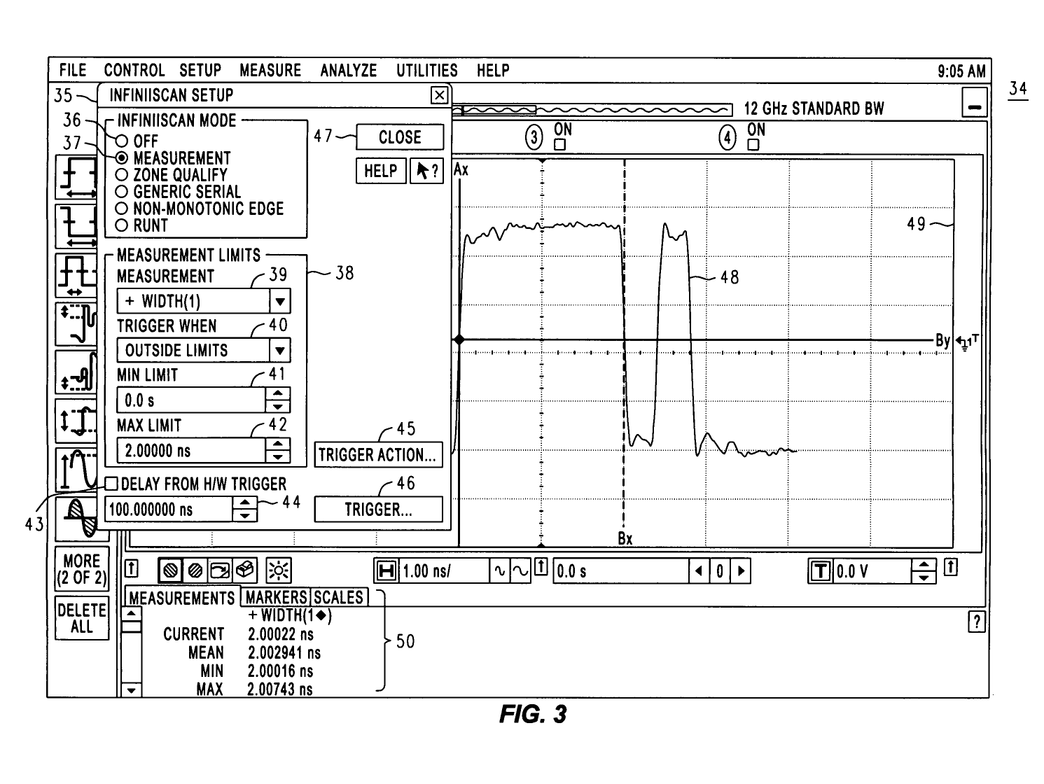

We turn now to FIGS. 3-12, which are illustrations of uses of a particular GUI used to specify the S/W Trigger component of various Composite Triggers. These GUIs are displayed in portions of the normal DSO display, which often includes a trace. In the figures we shall be interested in, that displayed trace will sometimes be for a H/W Trigger as an intermediate step toward defining a Composite Trigger, and will sometimes be the one that results from the Composite Triggering. It will be understood and appreciated that for each manner of S/W Triggering used as part of a Composite Trigger Specification, there is in the Oscillographic Application within the Embedded System 6 a corresponding section of executable code that implements detecting that particular S/W Trigger criterion. It will further be appreciated and understood that these sections of code are either conventional (as for an existing automatic measurement) or can be readily implemented by one of ordinary skill in the art, given the descriptions of the desired criteria that appear in FIGS. 3-12.

Without further ado, consider FIGS. 3-5. They describe a particular type of S/W Trigger that we shall term a “Measurement” Trigger. Such a S/W Trigger is based on the DSO's ability to perform an “automatic” measurement. These are measurements upon the waveform described by a trace that are susceptible to algorithmic implementation, and without the need for the operator to supply a contingent piece of information, such as identify a location along a waveform (which might be very difficult, since it does not yet exist as a displayed trace . . . ). Examples include such things as finding the period of a repetitive signal, or its rise time, finding a signal's peak-to-peak value, or its RMS value, etc. A modern top of the line DSO has quite a repertoire of such automatic measurements. For example, the series DSO8XXX, MSO8XXX and 548XX from Agilent Technologies, Inc. variously include:

| | | | | |
|---|---|---|---|---|
| Vₚ₋ₚ | Vₘᵢₙ | Vₘₐₓ | V_{avg} | Vᵣₘₛ |
| V_{base} | Vₜₒₚ | V_{lower} | V_{middle} | Vᵤₚₚₑᵣ |
| Rise Time | Fall Time | Period | Frequency | +width |
| −width | Duty Cycle | Tₘᵢₙ | Tₘₐₓ | Setup Time |
| Hold Time | Phase | Area | Slew Rate | Cycle-Cycle Jitter |
| etc. | | | | |

What we see in FIG. 3 is a screen 34 that was reached by invoking an “INFINISCAN” Mode in a menu on some other screen. In the DSO we are using as an example, the INFINISCAN Mode is a Composite Trigger Mode. Exactly what that previous screen might be is not of particular interest, as it might be any of a number, and the menu itself is likewise not out of the ordinary, save that it includes an INFINISCAN choice. So, once an operator has indicated that he/she wishes to define and invoke a Composite Trigger, a screen such as 34 appears, and includes dialog box 35 that allows the user to specify what kind of S/W Trigger is to be a part of the Composite Trigger. The associated H/W Trigger can already have been established, or might be established or changed later.

The example set out in FIGS. 3-5 pertains to an automatic measurement, which is one choice of five S/W Trigger types, in addition to OFF (36), which would end the definition or duration of a Composite Trigger specification. These (mutually exclusive) choices are set out as ‘radio’ buttons in dialog box 35, and we see that the MEASUREMENT button 37 has been clicked.

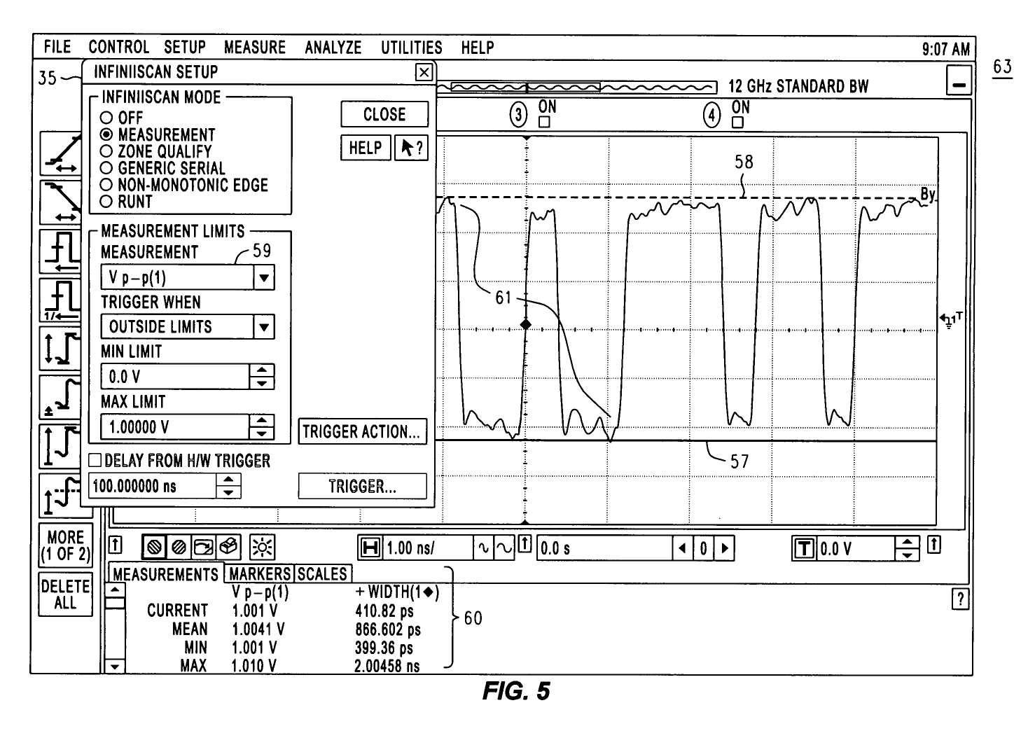

Once the MEASUREMENT button 36 has been clicked, a dialog box 38 pertaining to a Measurement S/W Trigger appears. Within that is a drop-down menu box 39 that allows the user to select which automatic measurement to use for the S/W Trigger. There are two generally equivalent ways for choices to appear in the list of the drop-down menu for box 39. The first is for the list to simply be a long one that contains all possibilities. That works, but might be awkward, it which case it might be a ‘self-subdividing’ list of a sort that it already well known. The other possibility is one that is actually implemented in the Agilent ‘scopes mentioned above. It is that there already is, for the prior art that uses automatic measurements, a manner of indicating what measurement to make on which channel. Furthermore, it often makes sense, and it is allowed, for there to be several measurements specified. In the Agilent ‘scopes, the specified measurements and their results are indicated with legends in regions 50 and 60, as in FIGS. 3 and 5, respectively. Such indications for up to five measurements can fit into the space available. In this second (other) possibility the drop-down list for menu box 39 is just those measurements that have already been specified by the usual for specifying automatic measurements, anyway, regardless of whether the intent is to use any of them as the S/W trigger component of a Composite Trigger.

In this example case the selection for the S/W Trigger is “+width” upon channel one. According to our notion of an ‘automatic measurement’ this is sufficient information to produce a measured parameter value (provided, of course, that channel one is in use and there is indeed a H/W Trigger . . . ). As far as a S/W Trigger criterion goes, some additional condition must be specified to allow a S/W trigger decision to be made based on the value of that measured parameter. Accordingly, menu boxes 41 and 42 allow the specification of minimum and maximum limits, respectively, for that measured parameter value. Menu box 40 (Trigger When) allows the choices “OUTSIDE LIMITS” and “INSIDE LIMITS” (not shown). The case of exact equality is excluded as improbable (and of relatively little utility in a typically noisy environment where time and voltage measurements are made to three or four digits).

To continue, the Composite Trigger specification is established and in effect as soon as the necessary information has been specified. There are however, some additional things the operator might wish to specify. He may, for example, wish to limit the portion of the Acquisition Record that is inspected by step 30 in FIG. 2A. By checking box 43 It can be limited to a region that is defined by some location relative to the location corresponding to the H/W Trigger and the end (latest in time) of the Acquisition Record. If he wishes to search the whole Acquisition Record, then this feature is not desired, and the box 43 is left unchecked. If this limiting feature is desired, however, then the box 43 is checked by clicking on it. The user then can enter, re-enter or increment/decrement a desired signed time offset in box 44 and that is to be used to specify the start-of-search location in the Acquisition Record for the S/W Trigger examination of step 30.

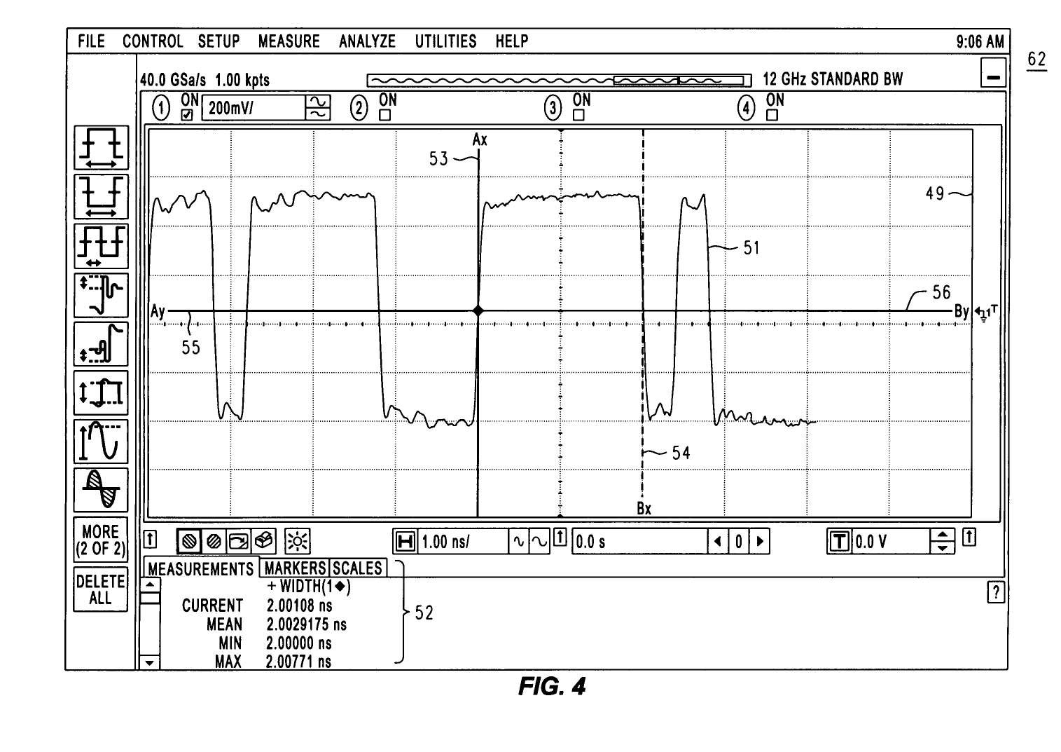

Here are some other things that are of interest in FIG. 3. It might be the case that the operator might like some action of convenience to occur subsequent to the occurrence of the Composite Trigger, such a notification by email, or any other action that can be described by statements in a batch file and carried out by the embedded system, perhaps in cahoots with an interface card responsive to the embedded system and coupled to an external environment. This sort of thing can be set up subsequent to clicking on the TRIGGER ACTION button 45. The TRIGGER . . . button 46 allows access to the H/W Trigger dialog, so that the H/W Trigger specification can be changed from within menu 35, if desired, or even initially established if that has not yet be accomplished. The CLOSE button 47 closes menu 35 so that the entire trace 48 within frame or window 49 is visible; see FIG. 4. Trace 48 is the normal trace that will be seen according to Composite Trigger operation according to the flowchart 16 of FIG. 2A. Finally, note region 50. It comprises various tabs, among which is one entitled MEASUREMENTS that summarizes various statistical properties associated with the automatic measurement that has been selected in box 39, and the instance of which is associated with the latest successful Composite Trigger.

Looking briefly now at FIG. 4, notice that the entire frame or window 49 is visible, as menu 35 has been CLOSE'd. Accordingly, the entire trace 51 is also visible. We can tell from these figures that the ‘scope is not STOP'ed, since the two traces 48 and 51 are not identical, and since the values shown in region 52 are slightly different from those shown in region 50. Notice also the measurement cursors Ax 53 and By 56. These are associated with the +width measurement performed as part of the Composite Trigger. Ax is placed at the start of the measurement discovered to lie outside the limits stated in the menu 35 (maximum of 2.00000 ns), as is confirmed by the annotation “CURRENT 2.00108 ns” in region 52.

Finally, as regards a ‘measurement style’ S/W Trigger, note FIG. 5. Here, the user has recalled the INFINISCAN SETUP menu 35, and changed the automatic measurement selected in drop-down menu box 59 to be Vₚ₋ₚ(1), which is a peak-to-peak voltage measurement on channel one. The S/W Trigger is declared to be when a measured peak-to-peak value is found that is outside the limits of zero to (plus) one volt. We see that excursion 61 meets the stated criteria.

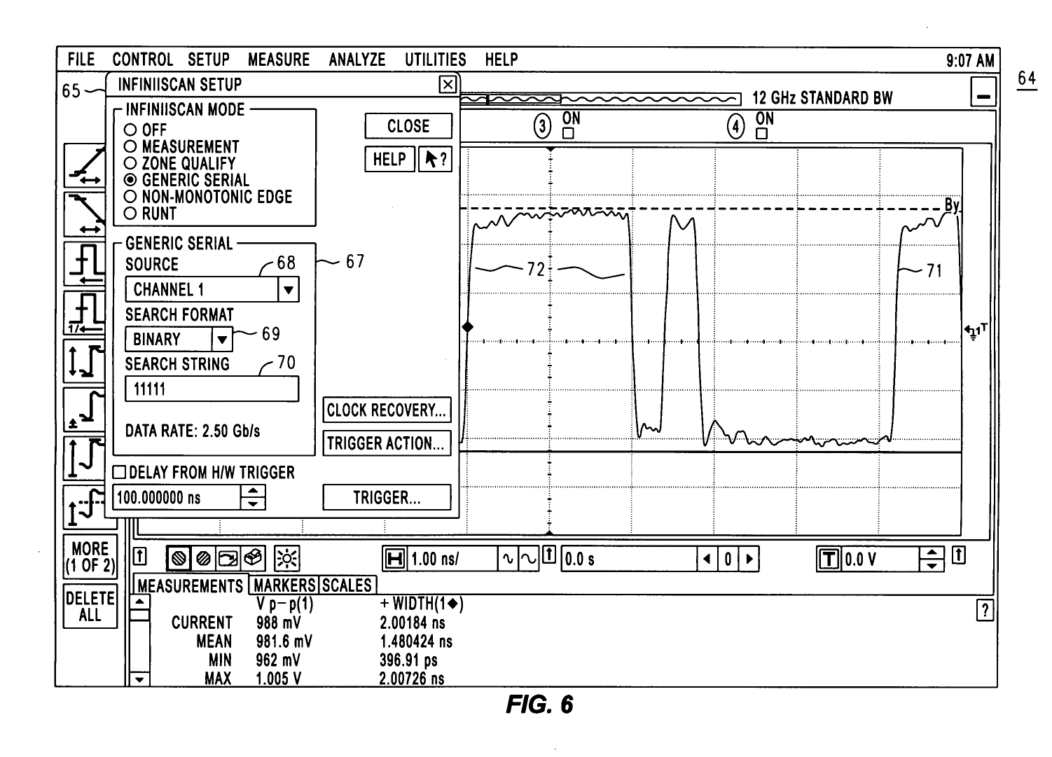

Refer now to FIG. 6. It depicts a screen 64 whose INFINISCAN (Composite Trigger) menu 65 has had the GENERIC SERIAL button 66 pressed. The means that the S/W Trigger component of a Composite Trigger is to be the detection in the Acquisition Record of some stated sequence of bits. The drop-down menu of box 68 is sued to select which input channel's signal is to be inspected for the stated sequence; in this example that is channel one. The drop-down menu of box 69 allows the operator to specify the format he or she will use to describe the string of bits that, if found, will constitute the S/W Trigger. In the present example that format is binary, which means that the only symbols permitted in the SEARCH STRING box 70 are 1 (binary ‘one’ bit), 0 (binary ‘zero’ bit) and an indicator whose meaning is ‘don't care’ (the symbol ‘X’ is often pressed into use for this service, as sometimes is ‘2’, among others). In the present example we see that the SEARCH STRING box 70 contains a string of five ones (11111). Lo and behold, note that the trace 71 has, at the location of the H/W Trigger, a wide positive excursion 72 that the ‘scope has located (having elsewhere already been informed through an existing conventional means of how to understand the issues of clocking, unit interval size and logic level voltage definitions). If we were actually operating the ‘scope in this example, we would appreciate waveform excursion 72 as five consecutive ones.

Now, while a serial bit pattern is always just a sequence of binary ones and zeros, not all descriptions of those bits are in binary. There are other notations, and these include octal, hexadecimal, ASCII, etc., and the symbols used to denote their values include much more that simply ‘1’ and ‘0’. These other notations are often considerably more convenient than regular binary, and are the remaining additional choices for the drop-down menu of box 69. If a different notation is specified in box 69, then indicia drawn from the corresponding collection of symbols is allowed in box 70, and that indicia is then properly construed as the described sequence of binary bits.

Finally, the search of the Acquisition Record will normally begin at its earliest portion, and proceed to its latest portion, so that the earliest portion of the waveform that satisfies the stated criteria is the ‘one that is found.’ If this is not the behavior desired, then just as with the automatic measurement example of FIGS. 3-5, the DELAY FROM H/W TRIGGER box can be checked (same as 43 in FIG. 3), and a value entered to locate where, relative to the H/W Trigger, to begin the search of the Acquisition Record.

We now turn our attention to a Composite Trigger based upon the specification of one or more ‘zones’ for a S/W Trigger. A zone is closed region in the time/vertical signal space that is defined by the operator and that has significance according to whether the trace for the signal of interest does or does not enter (or touch) the zone. In one actual product, up to two zones can be defined, and a S/W Trigger can be specified as being a particular behavior with respect to those zones by a given signal. In that particular embodiment a zone must be rectangular, but these various limitations are mere simplifications, and a zone could, in principle, be one of a large number of zones, some of which are associated with different traces, and, be of any arbitrary closed shape. We shall have more to say about each of these topics at more convenient times.

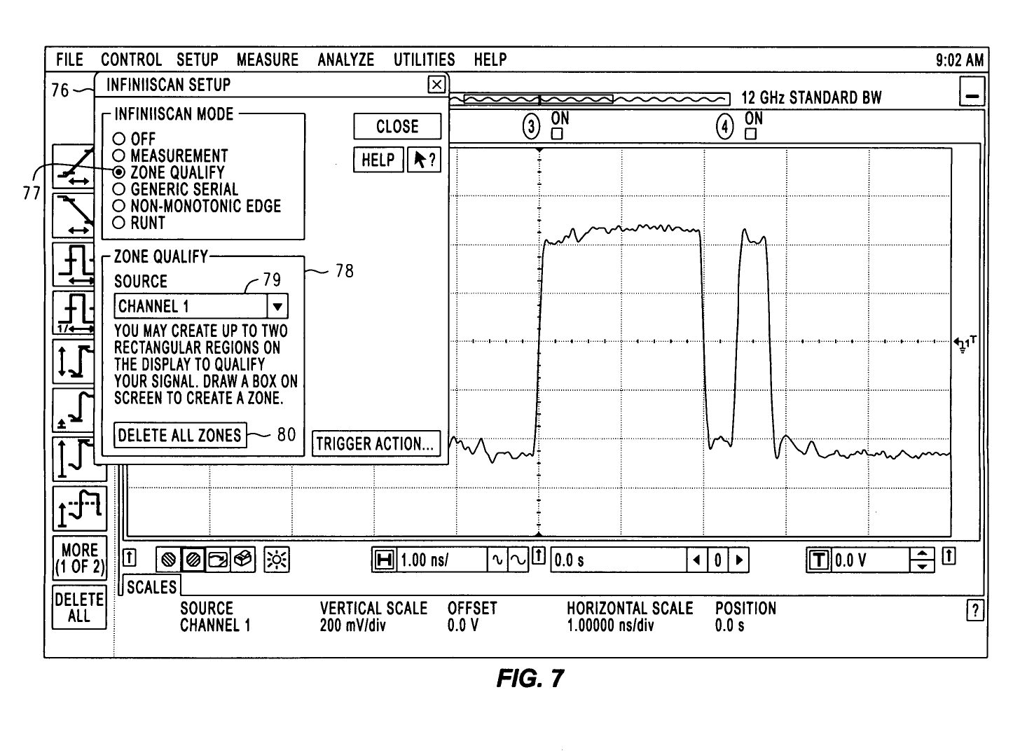

Refer now to FIG. 7. In this screen shot the user has once again conjured an INFINISCAN SETUP menu 76, subsequent to which the button 77 ZONE QUALIFY has been ‘pushed’ or checked. As a result a further menu portion 78 appears that is specific to ZONE QUALIFY. The further menu portion 78 includes a drop-down menu 79 that allows selection of the signal whose trace is to be compared against the one or more zones that will be defined. In the present example, CHANNEL 1 has been selected, which creates a context (or scope of control) that is associated with subsequently established zones. Since most ‘scopes have more than one channel, and since their traces all share the same ‘display space’ on the screen, there are some fundamental housekeeping issues that we need to look after if the notion of zones is to be easy to use and appreciate, lest it instead become confusing.

We said above that a zone is a closed region in the time/vertical signal space. By this we mean that it is not a static location on the surface of the screen. So, suppose you had a stable display and outlined on the screen with a grease pencil a zone of interest. Ignoring for the moment the obvious problem of how the ‘scope is to decide if the trace intercepts a grease pencil drawing on a glass faceplate, consider what happens if the display settings are changed to pan or zoom without changing the underlying Acquisition Record. Unless the location and aspect ratio of the grease pencil outline change in a corresponding way, a zone would be of very limited use! Or suppose the user simply vertically repositions the trace with the vertical position control to better see the entire excursion of the signal. It seems clear that a zone ought to be a region within the coordinate system that contains the trace, and as such, can be assigned pixels to represent it, just as is done for the rendered trace itself, and that “it moves when the trace moves.” In fact, why not think of it as actually being an adjunct to the trace, almost as if it were part of it? Say, items representing the zone could be added to the acquisition record, and understood as such by the rendering process.

Well, almost. Recall that the Acquisition Memory 5 is closely coupled to the Digitizer 4, operates at very high speed according to an interleaved architecture, and is a semi-autonomous ‘circular buffer’ mechanism, too boot. We are properly quite reluctant to interfere with this carefully engineered high performance aspect of the ‘scope's architecture. And upon further consideration, we appreciate that different locations in the Acquisition Memory may hold data that represents the same waveform feature from one instance of trace capture to the next, anyway. Evidently, we cannot associate particular static locations in the Acquisition Memory with a zone, even if we wanted to, because even if the captured waveform is ‘the same,’ we won't know where the next instance of the H/W Trigger will fall relative to the address space of the Acquisition Memory until it actually happens. HMmm. But we CAN say where a zone of such and such size and shape ought to be relative to the H/W Trigger event, and we CAN have an analytical description of that zone that is of a form that does not need to reside in the Acquisition Memory, proper.

Suppose, then, that for the sake of simplicity and illustration, we limit a zone to being a rectangular region having sides parallel to the horizontal (time) and vertical (voltage) axes of the trace for Channel One. Such a rectangle will have a lower left corner (P_{LL}), and can be fully described according to any of various formats, one of which is [P_{LL}, Height, Duration]. Let's say we have a list of such zones for each trace.

Now suppose that there has been a H/W Trigger and we wish to determine if some S/W Trigger condition involving zones is also met. There are different ways to address this issue, and depending upon the approach chosen, certain sneaky complications can arise. A brief digression will serve as an example of the sort of mischief that is afoot.

Consider the question: “Does this nut thread onto that screw?” Now, if the nut and screw are really at hand (e.g., lying loose on a table), and are neither too large nor too small to be handled, the easiest way to answer the question is to try the proposed operation using the actual items themselves. Leaving aside any extraneous difficulties associated with the actor doing the manipulation (blindness, lost hands in an accident, etc.), what we are getting at here is that the tangible items themselves will combine in nature to reveal the answer, and we really don't need to know anything at all about them, except how to attempt their manipulation. They will either do it according to some objective standard(s) of satisfaction (to be decided upon), or they won't. We don't need any information about the parts to find the answer if we can actually use the parts for the operation of interest. So, if a drunken machinist is turning out arbitrarily sized nuts and screws (arbitrary in the sense that, absent any notion of step size except what our tools can measure, as in how many different diameters are there between ⅛″ and 1″?), and we are given one of each, a foolproof way to get the answer is to simply try it. Such a trial is a form of analog computation akin to discovering how many 2+3 is by dropping two marbles into an empty bag, followed by dropping in three more, and then inspecting the result. (To bring this line of reasoning to a quick and merciful end, we realize immediately that a waveform to be measured and a zone defined by a user are not marbles that a ‘scope can scoop up and drop into a bag . . . .)

Now suppose we don't have the tangible items on hand, and are instead told by some interested interlocutors information about them. If we are told the nut is 4-40 (#4 in diameter, forty threads per inch) and the screw is ¼-20, we can, upon consulting with either our memory or available reference data, conclude that there is no way that this nut will thread onto that screw. If we thought that we were going to be confronted with these sorts of (well defined) questions on a regular basis, we might save much time by simply compiling ahead of time a look-up table or some other codified rule that we would rely upon for an authoritative answer. It is important to realize that the form of information given has a lot to do with whether or not this can be done. Probably only a small fraction of the parts turned out by our drunken machinist could be classified in the manner of this particular example (assuming someone actually devised a way to do so), and most of the time we would be unable to answer the question.

Responding to our protestations of difficulty, our interlocutors agree to be more reasonable. They give us two files stored in memory, with the admonition: “This is all that can and ever will be known about this nut and that screw. We must know the answer, as the fate of the universe hangs in the balance, etc.” So, it seems we are faced with construing two descriptions as bona fide virtual replacements for the real things, and do the best we can to mimic nature by using certain assumptions. That seems fair enough, and it doesn't take us long to come to that conclusion. And after a bit more consideration, we further realize that it matters a great deal to us how the items are described. One of the files is suspiciously short (it contains only the ASCII characters “nut, RH, 4-40”) and the other is several million bytes long and appears to contain an ASCII “screw, RH:” followed by an enormous amount of numerical data formatted according to some protocol whose rules are promised to us, if we but read this other document. We decide that we still have a dilemma. We either need a way to reliably discover if the long 25 file is equivalent to “screw, RH, 4-40” or a way to turn the short file into a second long one of the same protocol as the first long one. That is, unless we can have recourse to some outside authority (fat chance!), the two descriptions need to be of the same sort if we are to have any hope of ourselves comparing two arbitrary items. And that is assuming that we can develop a practical and reasonably reliable self-sufficient comparison process that operates by inspecting the two files, even if they are of the same type. To ensure that we appreciate our situation, our interlocutors offer a final word of advice: “We hired that machinist you mentioned. Don't be fooled by the existence of the short file—there is NO guarantee that the item described by the LONG file fits the 4-40, 6-32, 10-32, 10-24 paradigm . . . .” Evidently, converting a long file to a short file paradigm is a tenuous option, and we console ourselves with the knowledge that it is not too difficult to convert any short file we may be given to a long format version, and then rely upon a robust programmatic comparison mechanism. One of our engineering staff is heard to snort: “Well, that's what computers are for . . . .” But then there is another voice from the back of the room: “Maybe there will never be any short descriptions—they might all be long. And then might it not happen that even two identical screws could have non-identical long file descriptions, say, they started at different points on the screw . . . . The files only MEAN the same thing; but they themselves are NOT the same!” Indeed, there are some sneaky complications afoot! We suspect that this is so even after having gone to the trouble of ensuring that both descriptions are truly commensurable (constructed according to the same paradigm and format).

Leaving now the fable of the nut and the screw to return to the realm of digital ‘scopes, their traces and user defined zones, and as a convenient point of departure, suppose that we have some memory at our disposal. We are allowed to treat it as if it were a Frame Buffer, at least as far being able to store therein a bit mapped output from the Rendering Mechanism. Now, for each zone in a list of zones for a trace, render a region of the trace that has the same, or perhaps slightly more, duration. Now, render into the same memory the corresponding zone. (We may have to add to the Rendering Mechanism a zone appreciation mechanism, since a zone's description is not, after all, necessarily in the form of an Acquisition Record!) Now ask the question: “Do any of the pixels in one collection overlap pixels in the other (i.e., occupy the same location)?” One way to answer that question is to set a (previously cleared) flag meaning “YES” anytime a value for an illuminated pixel is written to a location that already contains an illuminated pixel value. By doing this for each zone, we would then be in a position to answer such questions as “Did the trace for Channel One go through this zone?” or “. . . through this zone and not through that one?” or “. . . through both?” That is, we are in a position now to decide upon a zone-based S/W Trigger, which may then be described as some Boolean expression involving intersections of one or more zones and its trace. And at this level, we can further see how this would work for more than one trace. In such a case we would say that we have several traces, each with a list of associated zones, and we evaluate a more complex Boolean expression involving several traces and their respectively associated zones.

We appreciate that what we have done here is to convert both the trace and the zone to a common pixel level description. (These would not necessarily have to be pixels that we need to display, or that are even displayable—think of a ‘pixel’ here as a ‘quantized thing.’) The rules of the universe appear to require both the (‘real’) trace and the (‘real’) zone to be continuous, so if their common pixel level descriptions (which are merely discrete quantized descriptions and are only ‘approximately’ continuous, even if we ‘connect the dots’) are sufficiently dense compared to events in the continuous domain, we feel comfortable with the idea that intersection will probably produce at least one common pixel for the two descriptions.

Well, maybe. There again is that voice from the back of the room: “You've zoomed way out and then defined the zone. How is a high speed glitch in the vicinity of your zone rendered? There are only 1024 horizontal pixel locations across the whole screen, you've spent it showing around a millisecond of signal, which is about a microsecond per pixel, and Charlie says the glitch is only a few nanoseconds long . . .” If this technique of comparison at the pixel level were to be our plan, and it were to be carried out at the visible level, then we would want assurances that the rendering mechanism won't lead us astray (i.e., the glitch is not carelessly filtered out). We consult with the rendering department, and are told that this is not necessarily fatal, as the rendering mechanism can be given criteria that functions as a form of peak detection/persistence for just such emergencies, so that if we are vigilant a short glitch or other significant feature will not fall ‘through the crack of the floor boards,’ as it were: an identifiable (but necessarily disproportionate) placeholder of some sort will appear in the collection of rendered pixels to ensure a common overlap between the set of pixels used to describe the zone and those used for the trace.

We begin to suspect that this ‘common pixel’ approach, while ‘operative’ is not, in its simplest form, anyway, totally reliable. It appears to lend itself to exceptions based on corner cases that may lead to confusion and a disgusted operator. On the other hand, it has one nice attraction, in that if we were determined to have a zone of arbitrarily defined shape (say, it was traced one the screen with mouse motion), then there are known ways to obtain a list of pixels that occupy the interior and perimeter of that zone. We leave this here for the moment, and will revisit these ideas once we have more to work with concerning the definition of a zone.

Continuing with our high level description of ‘scope operation, if there is no S/W Trigger, then the results are discarded, and operation continues. If the S/W Trigger condition is met, then the desired screen's worth of trace (as specified by the operator, say, relative to the H/W Trigger) is rendered into the real Frame Buffer and displayed. Any zones that fall within the displayed section of the trace are drawn by the GUI thread 18 of FIG. 2B.

Continuing now with FIG. 7, note that menu portion 78 also contains instructions to “DRAW A BOX ON THE SCREEN TO CREATE A ZONE” and a button 80 whose legend is “DELETE ALL ZONES”. Clicking on the button 80 will delete for the selected channel (from drop-down menu 79) any already defined zone associated with that selected channel. We can also appreciate that button 80 could instead be a drop-down menu itself, whose choices could be “DELETE ALL ZONES” and “DELETE SELECTED ZONE”. This latter action would apply to a previously defined zone that appears on the screen (as described below) and that has been ‘selected’ (e.g., highlighted by clicking on it).

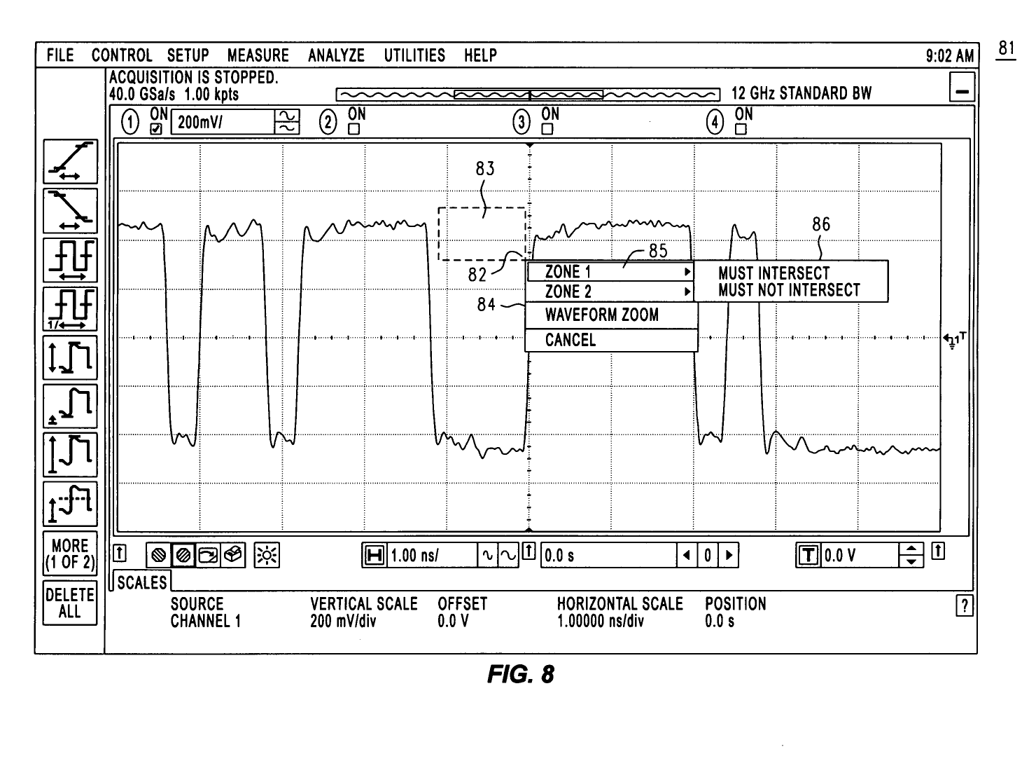

Refer now to FIG. 8. In this screen shot (81) the user has undertaken the creation of a zone, pursuant to the instructions in the menu portion 78 in FIG. 7. In particular, he has, in accordance with well known GUI techniques, positioned the screen pointer (mouse driven cursor, etc., and which is not itself shown) to some appropriate location (82). In this example the user intends to create a first rectangular ‘ZONE 1’ on the right of the trace for CHANNEL 1 and which the trace for CHANNEL 1 is to not intersect. One way to do that, and we shall suppose that such was what was done here, is to locate the lower right corner of the rectangle with the screen pointer, then hold down a mouse button while moving the mouse diagonally upward and to the left. During this operation the screen pointer changes from one style (say, a cross hair reticle or an arrow) to another that signifies that a ‘stretchy’ (and rectangular) sizing operation is under way. Dotted lines appear to show the resulting size and location of the (rectangular) zone (83) if the mouse button were released. When the user is satisfied with the size and location of the zone he releases the mouse button, the zone is represented by a solid line, and the normal screen pointer reappears. A menu 84 also appears, offering a choice of names (in this case, ‘ZONE 1’ and ‘ZONE 2’) as well as other choices described in due course. In our example the choice ‘ZONE 1’ has been selected, and the further sub-menu 86 subsequently appears. It offers the choices of ‘MUST INTERSECT’ and ‘MUST NOT INTERSECT’. By clicking on one of those choices the user informs the ‘scope what relationship between ZONE 1 and the trace of CHANNEL 1 is of interest.

The ‘CANCEL’ choice in menu 84 deletes the entire zone associated with that instance of the menu. The ‘WAVEFORM ZOOM’ choice changes the timing and/or voltage scaling of the waveform, rather than creating a zone.

In this connection, our illustration has had a trace displayed on the screen, which allows us to visually confirm that a zone is being specified in an appropriate location relative to that trace. This is certainly convenient, but is not, in principle anyway, absolutely necessary. Recall that we said that a zone was just a closed region in the display space, located relative to the H/W Trigger. If we knew, either from experience, wonderfully good guess-work, or hard analysis, just what the description of a suitable zone was, then one could imagine a zone-oriented GUI that had a menu that simply let us key that stuff in, sans mouse tracks. To be sure, ‘that stuff’ would likely NOT be a description rooted in the common pixel level (life is too short, and how would we get such a thing, anyway?). If we were able to use instead a compact and analytically precise description of some easy zone, such as a rectangle, things would be somewhat easier, although such a ‘manual’ system would still likely not be too convenient to use. We might often get disgusted when things don't work as supposed, owing to incorrect assumptions or to errors attributable to the sheer complexity of trying to keep mental track of all that stuff, some or much of which might be off-screen. After all, making life easier is supposedly what GUIs are all about. This view will, no doubt, add to the appreciation of why we have chosen to illustrate the creation of ‘ZONE 1’ with a GUI and against the backdrop of a trace of the sort (i.e., is an actual instance of one) that is related to the proposed zone. In this mode of operation we are using an existing instance of the trace as a convenient placeholder, or template, in lieu of an actual (yet to be acquired) trace whose particular shape will figure into the zone-oriented S/W Trigger.

Furthermore, it will be appreciated that the automatic determination by a programmatic system of the coordinates describing a visibly displayed object, such as a rectangle associated with, and created by a mouse controlled screen pointer, is a conventional accomplishment, and involves techniques known in themselves. In the case where a rectangle is created as indicated, in might be described with a collection of parameters that represent the Trace Number, Zone Number (for that trace) an Initial Starting Point, a Width, and a Height: [T_{N}, Z_{N}, P_{IS}, W, H]. For a four trace ‘scope T_{N} would range from one to four (or from zero to three or from A to D for persons of a certain other persuasion), Z_{N} would range from one to however many, P_{IS} would be an (X,Y) pair where the X is a signed offset in time from the H/W Trigger and Y is a voltage, W is a signed excursion away from X and H is a signed excursion away from Y. As mentioned above, the discovery of (X, Y) and of W and H from housekeeping parameters maintained by the ‘scope and the motion of the mouse is a task that whose accomplishment is known in the art.

As a further digression in connection with the definition of the size, shape and location of a zone, it can also be appreciated that the limitation of having a zone be a well behaved (think: easy to characterize) rectangle can be removed with the aid of techniques borrowed from the computer graphics arts that serve the community of solid modelers and CAD (Computer Aided Design) users (i.e., techniques found in their software and special purpose hardware packages). So, for example, if our ‘scope user were to be allowed to describe a zone by tracing an irregular but useful outline with a mouse controlled cursor, the zone's perimeter can be construed as a collection of linked line segments. This in turn amounts to a collection of one or more polygons occupying the interior of the zone, and the computer graphics art is replete with ways to perform polygon fill operations. That is, it is known how to find the collection of pixels, described in some arbitrary coordinate system, that occupy the perimeter and interior of a given polygon. (The task required here would not tax those arts in the least—they can even do it for collections of adjoining polygons that lie on a curved surface, where parts of that surface are to be trimmed away at the intersection with yet another surface . . . .) Once the collection of such pixels is known it is not difficult to detect their intersection or not with those of a nearby trace. (We have already alluded to one way: sharing of a common pixel location. Another is to detect an intersection of a line segment formed by two adjacent pixels in the trace with a line segment on the boundary of a polygon belonging to the zone.) The principal difference between this more general shape for a zone and the earlier well behaved rectangle is that the rectangle can be more simply described symbolically as a [P_{IS}, W, H] and the temptation is to then use simple comparisons to horizontal and vertical ranges to ascertain if any (think: each) ‘nearby’ point on the trace falls within the rectangle, or that none do.

We also realize that there is a significant operational difference between comparing a trace segment expressed as a complete (think: ‘long’) list of discrete values (whether as measured or as rendered into pixel locations) against a (long) comparably formatted “complete” list of values representing an arbitrary zone, on the one hand, and on the other, comparing against a compact (analytical) description for a ‘well behaved’ zone that is tempting precisely because it is brief. It is not so much that one way is right and the other is wrong. It is more that each has its own type of sneaky mischief. We needn't get stuck here, and it is sufficient to suggest some of the traps. No list of points will ever exhaust those that might be needed along a line, or worse, within a region. So examining two lists to find commonality can't be trusted absolutely to produce a proper intersection/non-intersection determination. We find ourselves on the one hand invoking Nyquist and bandwidth limitations, while on the other hand complaining about the large amounts of memory needed to always render at a resolution commensurate with bandwidth. Smart rendering can help, as can some other techniques.

Now at this point it will not be surprising if we observe that comparison at the common pixel level is outwardly convenient (since a ‘scope already has a Rendering Mechanism for producing such pixels, whether to be displayed or not), but is ‘rendering sensitive,’ as it were. We note also that if we were intent upon it, we could consume much memory and render to some other minutely quantized level of description that is never displayed as such. To implement such a ‘split personality’ might be confusing, even if we were careful to be consistent, since there may arise questions concerning the possibility that the displayed results (rendered one way) might not match the invisible results (rendered another way) upon which Composite Trigger decisions are based. Furthermore, add-on rules for the different renderings may or may not always solve the problem, although in general the results can be quite satisfactory. We suspect that the price for this outward convenience is higher than thought at first glance.

Finally, it seems that no matter how we proceed, we eventually do end up using a variant of one or both of these two decisions: “Is this described location (i.e., a pixel-like item, whether displayable in the Frame Buffer or a non displayed resident in some ‘comparison space’) shared with another (comparable) collection of described locations?” and “Does this line segment (known by its end points) intersect any of those (similarly known) line segments?” At the end of the day, we begin to appreciate why computer graphics systems have such a voracious appetite for processing power: they take such baby steps, and there are so very many to take . . . .

It is now easy to appreciate the relative ease with which the notion of a zone can be implemented by a rectangular region R of X_{LEFT} to X_{RIGHT} and of Y_{UP} to Y_{DOWN} [described analytically as the points (X_{L}, Y_{D}), (X_{R}, Y_{D}), (X_{R}, Y_{U}), (X_{L},Y_{U})] by asking if each member (X_{P}, Y_{P}) of the Acquisition Record (perhaps after some digital signal processing for fidelity purposes, but not yet as rendered for Frame Buffer use!) meets the condition:

(X_{L}≦X_{P}≦X_{R}) AND (Y_{D}≦Y_{P}≦Y_{U})

If this logical conjunction is TRUE, then we can declare that the trace has entered or touched the region R. Equally important, we can also be absolutely certain that, if that logical conjunction is FALSE, then the trace did not enter or touch the zone. Note that only simple comparisons on one axis at a time are needed: there is no need to check, say, the vertical axis unless the time axis condition is already met. Furthermore, we can state these comparisons in terms of actual times (relative to the time reference) and voltages. This is asking if members of the Acquisition Record fall within the shadow, as it were, of a range, which is somewhat different than asking if two disparate descriptions become quantized into a use of the same descriptor (pixel location). Upon reflection, we appreciate that the orthogonal nature of the display space axes, and a requirement that the sides of the rectangle be parallel to those axes, allows us to detect that two line segments intersect without going through the pain of having to construct (solve for) the intersection. We decide that, for those reasons, we prefer rectangular zones, or ‘composite zones’ made up of a reasonable number of nicely oriented adjacent rectangles.

We can similarly find the comparable answer for that trace and another zone, as well as for another trace and any zone. In a multiple zone case, it is then just a matter of recognizing a desired corresponding pattern of TRUE and FALSE for however many of those zones that have been invoked as part of a Composite Trigger specification.

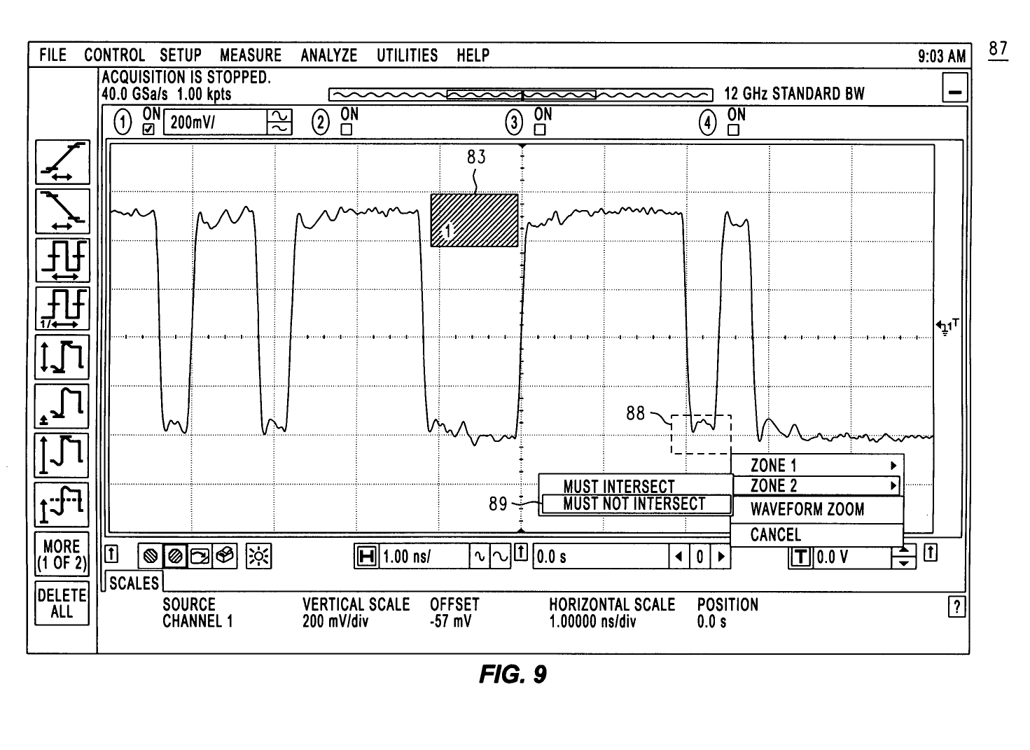

Now consider FIG. 9. This is a screen shot 87 where the type of operations that defined ZONE 1 (83) are repeated to define another ZONE 2 (88) (and that is also in the path of the trace) which is subsequently specified as MUST NOT INTERSECT (89).

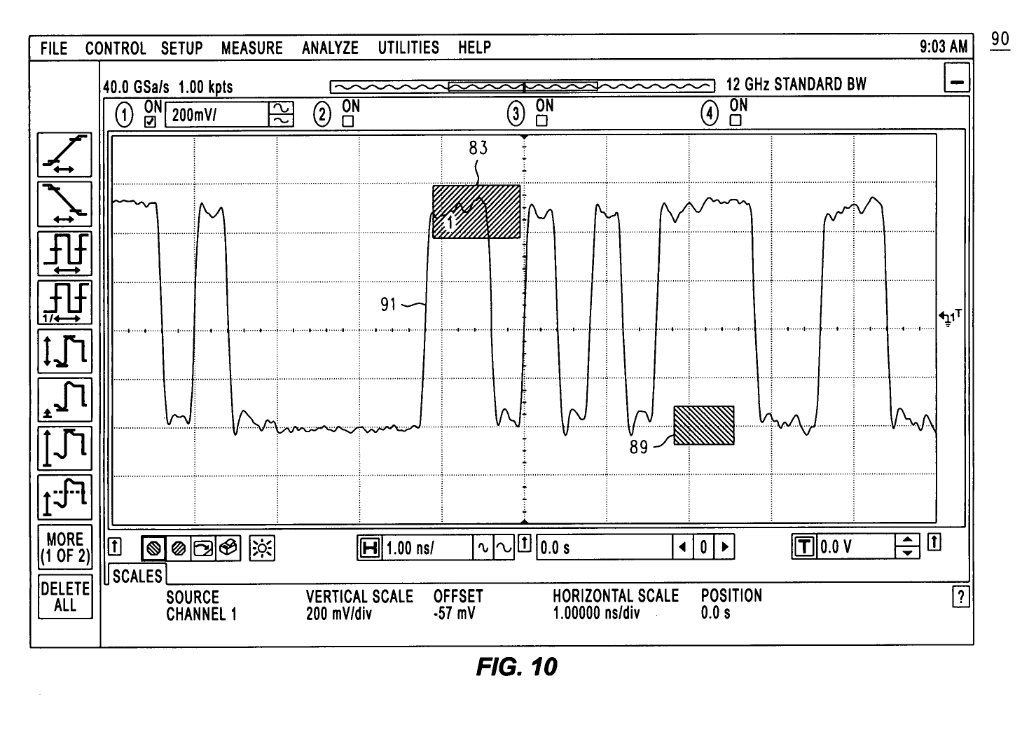

In FIG. 10 we see a subsequent screen shot 90 where a trace met the Composite Trigger conditions associated with FIG. 9. It will be noted that the trace 91 does pass through ZONE 1 (83) and does not pass through ZONE 2 (89).

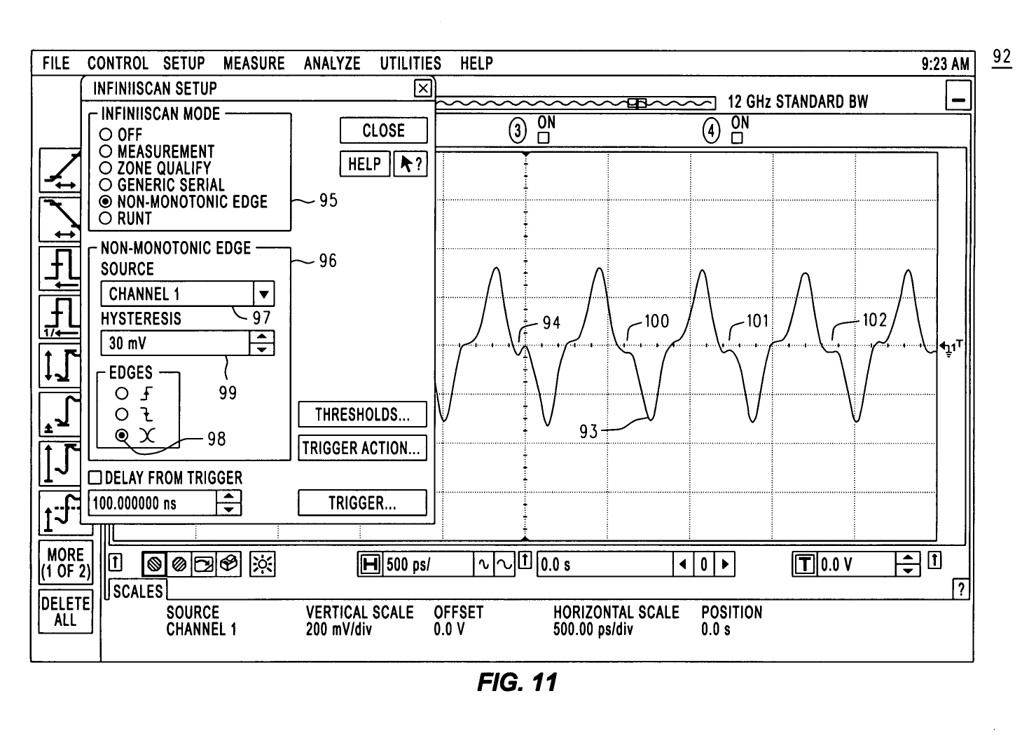

We turn now to another manner of S/W Trigger that can be used as part of a Composite Trigger condition: lack of monotonicity on an edge. With reference then to FIG. 11, it shows a screen shot 92 whose trace 93 contains a falling edge having a “hiccup” 94 that is a falling-rising-falling region within the falling edge. Here is how this sort of S/W Trigger portion of a Composite Trigger is specified.

Once again the operator has conjured the INFINISCAN Mode menu 95, and then selected (clicked on) the button marked ‘NON-MONOTONIC EDGE.’ With that done, the system produces the menu portion 96, which is specific to that choice. Within menu portion 96 are three choices for edges: rising, falling, or either. In this case, the operator clicked on the button 98 for ‘either.’

At this point we must digress slightly to establish what is meant by an ‘edge.’ There are other automatic measurements that the ‘scope can make, and pursuant to those the system needs to know the excursion limits of the signal of interest. That is, its maximum and minimum values. For various reasons it is typical for the respective 90% and 10% values of those two excursion limits to be called the ‘measurement limits.’ Such measurement limits can be found automatically using the 90%/10% criterion, found automatically using a different percentage, or simply specified as this voltage and that voltage. (The IEEE has also published a standard 181-2003 that defines what an ‘edge’ is.) We here stipulate that the identification or specification of such measurement limits is conventional, and we will consider an edge to be points along the trace that lie between the measurement limits. If the Y value (voltage) of an entry in the Acquisition Record falls within the measurement limits it can be considered to lie on either a rising or falling edge, and forming the ΔY for successive pixels will indicate which.

One way to proceed is to traverse the Acquisition Record and maintain in running fashion useful indicators about whether the current location is part of an edge, and if so, whether rising or falling. Now we need an operational definition of non-monotonic. We might look for sign reversals for a piece-wise first derivative that are inspired by inflections in the trace. This approach can open the door to ‘noise on flat spots’ looking like a failure to be monotonic. Filtering by digital signal processing can be a cure for this, but its description is more suited to the frequency domain than to the natural time domain of a waveform. A hysteresis value H is the easy cure for this in the time domain, and leads us instead to this definition: If, for the duration of a falling edge a voltage value for a subsequent point along that edge is greater than H plus the voltage value of any prior point on the edge, then the edge is non-monotonic. For a rising edge, if the voltage value of a subsequent point is less than the voltage of any prior point along the edge as diminished by H, then that edge is non-monotonic. We now have most of the tools we need to implement a S/W Trigger based on a non-monotonic edge.

The hysteresis value H is supplied/edited by manipulating the content of box 99 in the menu portion 96.

For the example of FIG. 11 we shall examine all rising or falling edges. The ability to specify a hysteresis value H is what allows ‘hiccups’ 100, 101 and 102 in FIG. 11 to be excluded from satisfying a S/W Trigger for non-monotonicity. Transition 94 would satisfy the (example) S/W Trigger component of a Composite Trigger based on non-monotonicity, and the trace would then appear as shown in the display, with the non-monotonic region 94 located at the time reference.

Finally, we touch briefly on the detection of a runt excursion for use as the S/W component of a Composite Trigger. The operational definition is this. If a waveform descend through the lower measurement limit, then later rises by H and then descends again to the lower measurement limit without having first reached the upper measurement limit, it is a runt. If a waveform rises through the upper measurement limit, then later falls by H and then rises again to the upper measurement limit without having first reached the lower measurement limit, it is also a runt.

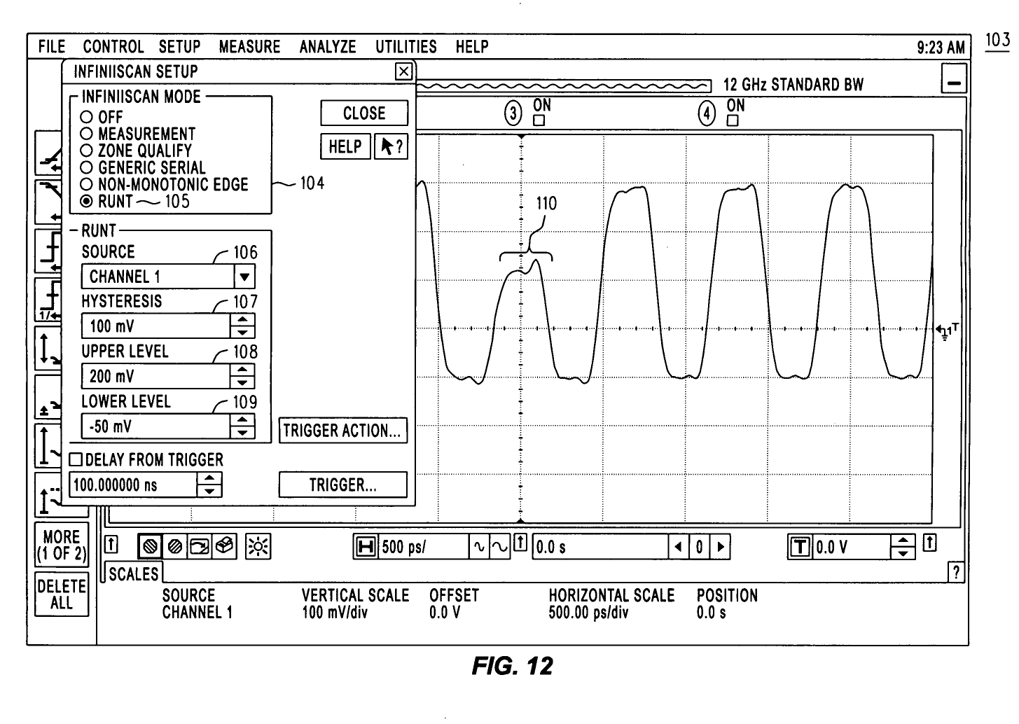

FIG. 12 shows a screen shot 103 of the set-up situation. The INFINISCAN Menu 104 has obscured the legend that indicates that the trace is for CHANNEL 1 at 100 mV per division. However, knowing that information we can appreciate that a RUNT (105) S/W Trigger component has been selected for a source that is CHANNEL 1 (106). In this case the operator has specified that the upper measurement limit is 200 mV (108) and that the lower measurement limit is −50 mV (109). The hysteresis value (107) of 100 mV indicates that once there has been a ΔV of 100 mV an edge has been achieved, so that if V does not subsequently ascend (or descend) to the opposing measurement limit before the departed-from measurement limit is again reached, a RUNT has occurred. Thus, region 110 represents a RUNT.

I claim:

1. A method of triggering a digital oscilloscope while measuring an electrical signal of interest, the method comprising the steps of:
(a) measuring the behavior of the electrical signal of interest by storing in an acquisition record digitized sampled values of the electrical signal of interest;
(b) defining a hardware trigger criterion;
(c) defining a software trigger criterion pertaining to measured behavior of the signal of interest as stored in the acquisition record;
(d) during step (a), detecting a satisfaction of the hardware trigger criterion of step (b);
(e) subsequent to an instance of detecting a satisfied hardware trigger criterion in step (d), examining the acquisition record to detect a satisfaction of the software trigger criterion of step (c); and
(f) subsequent to an instance of detecting a satisfied software trigger criterion in step (e), displaying as an oscillographic trace a selected portion of the content of the acquisition record.

2. A method as in claim 1 wherein the hardware trigger criterion pertains to detectable analog behavior of the signal of interest.

3. A method as in claim 1 wherein an acquisition record that produces a satisfaction of the software trigger criteria of step (c) is maintained in being until a subsequent instance of another acquisition record produces a subsequent satisfaction of the software trigger criterion of step (c).

4. A method as in claim 1 wherein subsequent to an initial filling of the acquisition memory oldest values therein are overwritten by newest ones.

5. A method as in claim 1 further comprising the step of performing one or more waveform measurements upon only those waveforms that are contained in Acquisition Records whose content produced a satisfaction of the software trigger criterion of step (e).

6. A method as in claim 1 further comprising the steps of inspecting, subsequent to an instance of detecting a satisfied hardware trigger criterion in step (d), the values stored in the acquisition record, and of measuring under algorithmic control a selected parameter associated with waveform measurement, and wherein the software trigger criterion defined in step (c) comprises choosing the selected parameter to be measured under algorithmic control and specifying a condition to compare the measured selected parameter against.

7. A method as in claim 1 wherein the software trigger criterion defined in step (c) comprises a serial bit pattern.

8. A method as in claim 1 wherein the software trigger criterion defined in step (c) comprises defining a closed region relative to the displayed selected portion of the oscillographic trace and a criterion pertaining to intersection of that closed region by the oscillographic trace.

9. A method as in claim 1 wherein the software trigger criterion defined in step (c) comprises non-monotonic behavior of a transition in the signal of interest.

10. A method as in claim 9 wherein the non-monotonic behavior is qualified by a selected value of hysteresis.

11. A method as in claim 1 wherein the software trigger criterion defined in step (c) comprises a runt excursion in the signal of interest.

12. A method as in claim 11 wherein the determination of a runt excursion is qualified by a selected value of hysteresis.

13. Composite trigger apparatus for a digital oscilloscope comprising:
an analog to digital converter that samples and digitizes an input signal to be measured into discrete digital values presented at an output;
an acquisition memory coupled to the output of the analog to digital converter and that stores an acquisition record representing a waveform describing the measured electrical behavior of the input signal, wherein once the acquisition memory is full oldest values are overwritten by newest ones;
a hardware trigger circuit having an input coupled to the input signal and producing a hardware trigger signal;
a timing circuit coupled to the hardware trigger signal, to the analog to digital converter and to the acquisition memory, and that halts the production of an acquisition record a selected length of time after the occurrence of the hardware trigger signal;
an acquisition buffer coupled to receive the acquisition record from the acquisition memory subsequent to the occurrence of a hardware trigger signal;
a programmatic mechanism coupled to the hardware trigger signal, to the acquisition buffer and responsive to commands from an operator of the oscilloscope, that subsequent to an instance of the hardware trigger signal performs an algorithmic inspection of the acquisition record in the acquisition buffer to determine if measured input signal behavior meets a selected criteria, and which produces a software trigger if the determination by the algorithmic investigation is in the affirmative;
a rendering mechanism coupled to the acquisition buffer that creates a displayable bit-mapped image of a selected portion of the acquisition record; and
a frame buffer coupled to the rendering mechanism and that stores the displayable bit-mapped image.

14. Apparatus as in claim 13 wherein the algorithmic inspection of the acquisition record by the programmatic mechanism measures a selected parameter associated with waveform measurement and compares it against a specified condition.

15. Apparatus as in claim 13 wherein the algorithmic inspection of the acquisition record by the programmatic mechanism inspects the acquisition record for a selected serial bit pattern.

16. Apparatus as in claim 13 wherein the algorithmic inspection of the acquisition record by the programmatic mechanism determines if the measured signal exhibits a selected relationship to a selected closed region in a (time, voltage) space occupied by the measured signal.

17. Apparatus as in claim 13 wherein the algorithmic inspection of the acquisition record by the programmatic mechanism inspects for non-monotonic behavior of a transition in the measured signal.

18. Apparatus as in claim 17 wherein the non-monotonic behavior is qualified by a selected value of hysteresis.

19. Apparatus as in claim 13 wherein the algorithmic inspection of the acquisition record by the programmatic mechanism inspects for a runt excursion in the measured input signal.

20. Apparatus as in claim 19 wherein the determination of a runt excursion is qualified by a selected value of hysteresis.
